(19) United States
(12) Patent Application Publication
(10) Pub. No.: US 2020/0043052 A1
(43) Pub. Date: Feb. 6, 2020

(54) INFORMATION PROCESSING APPARATUS AND INFORMATION PROCESSING METHOD

(71) Applicant: TOYOTA JIDOSHA KABUSHIKI KAISHA, Toyota-shi (JP)

(72) Inventors: Kazuaki TAKEMURA, Nagoya-shi (JP); Yuko MIZUNO, Nagoya-shi (JP); Kohei MUTO, Toyota-shi (JP); Keiko NAGATOMI, Toyota-shi (JP); Masatoshi KOMIYAMA, Handa-shi (JP); Kuniaki JINNAI, Nagoya-shi (JP)

(73) Assignee: TOYOTA JIDOSHA KABUSHIKI KAISHA, Toyota-shi (JP)

(21) Appl. No.: 16/527,236

(22) Filed: Jul. 31, 2019

(30) Foreign Application Priority Data
Aug. 6, 2018 (JP) 2018-147851

(51) Int. Cl. G06Q 30/02; G01C 21/34; G01C 21/36

(52) U.S. Cl. CPC G06Q 30/0266; G01C 21/3617; G01C 21/3476; G06Q 30/0244

(57) ABSTRACT

An information processing apparatus comprises a control unit configured to execute the processing of: obtaining first information, which relates to a specific location related to an advertisement displayed by a display apparatus provided on a first vehicle; obtaining route information, which is information about a route to the specific location, on the basis of the first information; and providing the obtained route information to a user.

### CROSS REFERENCE TO RELATED APPLICATION

This application claims the benefit of Japanese Patent Application No. 2018-147851, filed on Aug. 6, 2018, which is hereby incorporated by reference herein in its entirety.

### BACKGROUND

### Technical Field

The present disclosure relates to technologies of providing advertisements using vehicles as media.

### Description of the Related Art

Advertising using vehicles as media has been developed in recent years. For example, an outside display apparatus is provided on a vehicle to display advertisements. The advertisement to be displayed is dynamically selected appropriately according to circumstances to optimize the effect of advertising.

### CITATION LIST

### Patent Literature

Patent Literature 1: Japanese Patent Application Laid-Open No. 2006-209280

### SUMMARY

To enhance the effect of advertisements displayed using vehicles as media, it is desirable to invite customers who have seen the advertisements to access locations relating to the advertisements. For example, in the case of an advertisement about a sale in a store, it is desirable to show the way to the store.

The present disclosure has been made in the above circumstances, and an object of the present disclosure is to provide a system that can guide users to locations relating to advertisements displayed using vehicles as advertising media.

The present disclosure in its one aspect provides an information processing apparatus comprising a control unit configured to execute the processing of obtaining first information, which relates to a specific location related to an advertisement displayed by a display apparatus provided on a first vehicle; obtaining route information, which is information about a route to the specific location, on the basis of the first information; and providing the obtained route information to a user.

The present disclosure in its another aspect provides an information processing method comprising the following steps executed by an information processing apparatus, obtaining first information, which relates to a specific location related to an advertisement displayed by a display apparatus provided on a first vehicle; obtaining route information, which is information about a route to the specific location on the basis of the first information; and providing the obtained route information to a user.

An information processing apparatus according to a third aspect of the present disclosure comprises a program that causes a computer to implement the above-described information processing method or a computer-readable recording medium in which the program is stored in a non-transitory manner.

The apparatus or method according to the present disclosure can guide users to locations relating to advertisements displayed using vehicles as advertising media.

### BRIEF DESCRIPTION OF THE DRAWINGS

FIG. 1 is a diagram illustrating the general configuration of an advertisement distribution system according to an embodiment.

FIG. 2 is a diagram illustrating the system configuration of a vehicle 10 according to a first embodiment.

FIG. 3 illustrates the positions of display apparatuses provided on vehicles 10.

FIG. 4 is a diagram illustrating the system configuration of a server apparatus 20 according to the first embodiment.

FIG. 5 illustrates an example of an advertisement information table stored in a database.

FIG. 6 illustrates an example of a vehicle information table stored in a database.

FIG. 7 illustrates an example of a travel record table stored in a database.

FIG. 8 is a diagram illustrating the system configuration of an on-vehicle terminal 30 according to the first embodiment.

FIG. 9 is a flow chart of a process executed by the server apparatus 20.

FIG. 10 is a flow chart of a process executed by the vehicle 10.

FIG. 11 is a flow chart of a process of providing route information according to the first embodiment.

FIG. 12 is a flow chart of a process of providing route information according to a second embodiment.

FIG. 13 is a flow chart of a process of providing route information according to a third embodiment.

FIG. 14 is a flow chart of a process of providing route information according to a fourth embodiment.

### DESCRIPTION OF THE EMBODIMENTS

An advertisement distribution system according to the present disclosure includes a server apparatus and a plurality of vehicles. The server apparatus distributes an advertisement to the plurality of vehicles, and the vehicles display the advertisement on their respective display apparatuses.

Each vehicle in the system according to the embodiment outputs an advertisement (in the form of a still or moving image) it has received from the server apparatus on an outside display apparatus provided on the vehicle body while it is travelling. It is desirable for the system as above to provide circumstances that allow consumers who have seen the advertisement to easily access a location related to the advertisement (e.g. a store). Such consumers will be hereinafter referred to as “users”.

An information processing apparatus according to the present disclosure obtains first information, which relates to a specific location related to an advertisement displayed by a display apparatus provided on a first vehicle, and route information, which is information about a route to the specific location, on the basis of the first information and then provides the obtained route information to a user.

The first vehicle is a vehicle that outputs an advertisement by a display apparatus.

The first information may be any information about a location related to the advertisement displayed by the vehicle. Examples of the first information includes identification data of a store or facility related to the advertisement and location information indicating the location of the store or facility.

The route information for the location related to the advertisement may be created by the information processing apparatus or retrieved using an external service. The route information may be sent to a terminal related to the user or a route guidance apparatus provided on a vehicle.

The above apparatus can guide the user to the location related to the advertisement displayed by the vehicle.

The control unit may obtain the first information by performing an inter-vehicle communication with the first vehicle.

The control unit may obtain the first information from a server apparatus that manages distribution of the advertisement to the first vehicle.

The use of an inter-vehicle communication can expedite the obtainment of information. The communication with the server apparatus that manages distribution of the advertisement can improve the reliability of obtainment of information about the advertisement.

The control unit may be configured to send to the server apparatus second information that is used to identify the advertisement displayed by the first vehicle.

Examples of the second information include, but are not limited to, data about time and date, data about a location, identification data of the vehicle, and identification data of the advertisement. The server apparatus can identify the advertisement seen by the user by comparing such information with management information.

The control unit may be configured to create the second information on the basis of an image of the first vehicle captured by a camera provided on a second vehicle on which the user is aboard.

The second vehicle is a vehicle on which the user who sees the advertisement is aboard. The advertisement can be identified quickly by using an image captured by a camera. Examples of information used to identify the advertisement may include a feature produced from the image, a result of recognition of a pattern (e.g. two-dimensional code) contained in the image.

The control unit may obtain the second information by performing an inter-vehicle communication with the first vehicle.

In this case, the second information may be information about the number plate (license plate) or identification data of the vehicle in the system.

When the control unit obtains a plurality of pieces of the first information, the control unit may obtain a plurality of pieces of the route information corresponding respectively to them and provide the plurality of pieces of route information to the user with prioritization.

When there are a plurality of advertisements that have possibly been seen by the user, and it is not possible to identify the advertisement seen by the users, location information related to the plurality of advertisements may be obtained and provided to the user with prioritization of the advertisements. The prioritization may be performed based on the taste of the user or the physical or logical distance between the vehicles.

In the following, specific embodiments of the present disclosure will be described with reference to the drawings. It should be understood that features such as hardware configurations, module configurations, and functional configurations that will be described in connection with the embodiments are not intended to limit the technical scope of the present disclosure only to them, unless otherwise stated.

### First Embodiment

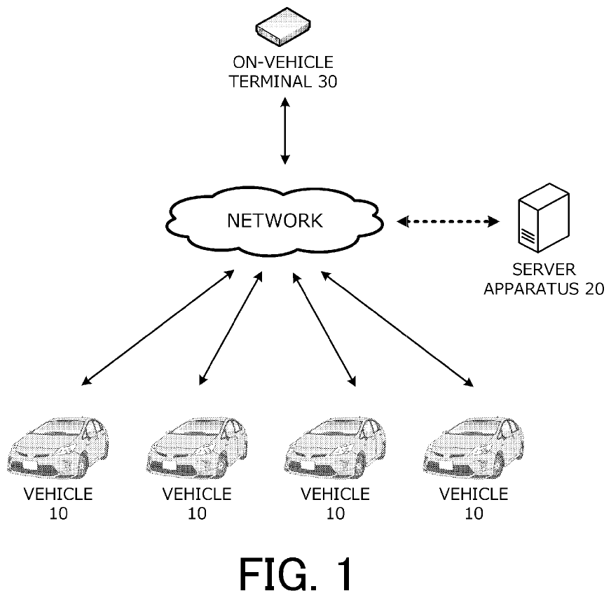

FIG. 1 illustrates the general configuration of an advertisement distribution system according to a first embodiment. The advertisement distribution system according to the first embodiment includes a plurality of vehicles 10, a server apparatus 20, and on-vehicle terminals 30 related with users. In the context of the description of this embodiment, the term “users” refers to an intended audience of an advertisement output by the vehicles 10.

The vehicle 10 is an automobile provided with a plurality of display apparatuses on the outside of its body. The vehicle 10 is capable of displaying an advertisement using advertisement data it has received from the server apparatus 20. The expression “displaying an advertisement” in the description of the embodiment means outputting image data to a display apparatus to display a still or moving image on it. The number of vehicles 10 included in the system is not limited to that in the illustrated case, but the system may include any number of vehicles 10.

The vehicle 10 receives advertisement data from the server apparatus 20 and outputs an advertisement to the display apparatuses while it is travelling. The vehicle 10 periodically sends information about the state of display of an advertisement (e.g. location information and information identifying the advertisement displayed) to the server apparatus 20.

The server apparatus 20 is a server that manages the vehicles 10 and advertisements to be displayed by the vehicles 10. The server apparatus 20 has data relating to advertising and data about the vehicles 10. The server apparatus 20 determines advertisements to be distributed to the vehicles 10, distributes advertisements to the vehicles 10, and performs management of results (e.g. makes a report to the advertiser or client).

The server apparatus 20 also manages the locations of travelling vehicles 10, records of their travel, identification data of the advertisements displayed by the vehicles 10.

The on-vehicle terminal 30 is a terminal related to a consumer (a user). The vehicle on which the on-vehicle terminal 30 is provided may be any vehicle on which the user is aboard, which is not necessarily a vehicle 10 used to display advertisements. In the following, vehicles on which users are aboard will be referred to as “user vehicle(s)”, which are discriminated from the vehicles 10 that display advertisements. The number of on-vehicle terminals 30 included in the system is not limited to that in the illustrated case, but the system may include any number of on-vehicle terminals 30.

When requested from an on-vehicle terminal 30, the server apparatus 20 determines an advertisement that is supposed to have seen by the user and sends information about the location related to the advertisement to the on-vehicle terminal 30. Then, the on-vehicle terminal 30 creates a route to the location related to the advertisement and provides it to the user. This enables the user to be guided to the location related to the advertisement.

The vehicles 10, the server apparatus 20, and the on-vehicle terminals 30 in the advertisement distribution system according to the embodiment are interconnected by a network. Examples of the network include a wide area network (WAN), namely a global public network, such as the Internet, and other communication networks. Examples of the network also include a telephone communication network, such as a cellular phone network, and other wireless communication networks, such as Wi-Fi (registered trademark).

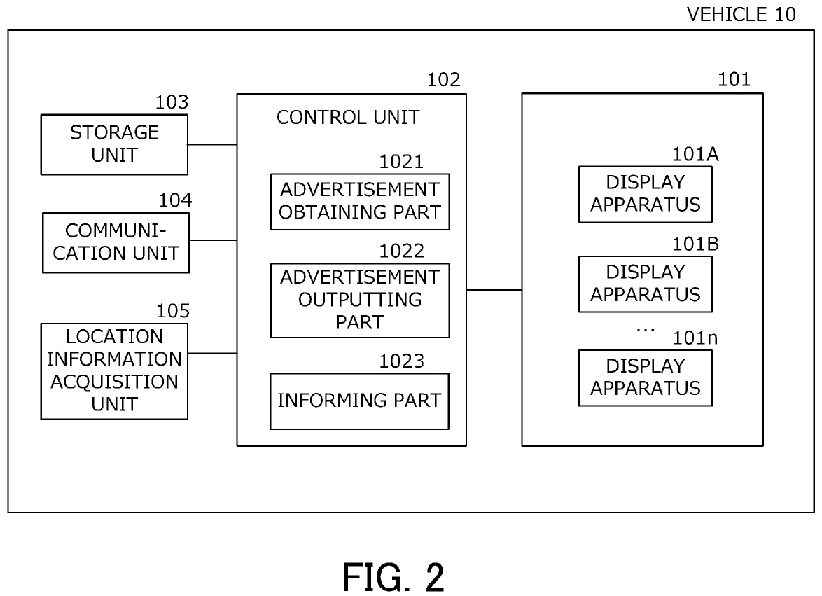

Now, the configuration of the vehicle 10 will be described. FIG. 2 is a diagram illustrating the system configuration of the vehicle 10.

The vehicle 10 includes a display unit 101, a control unit 102, a storage unit 103, a communication unit 104, and a location information acquisition unit 105.

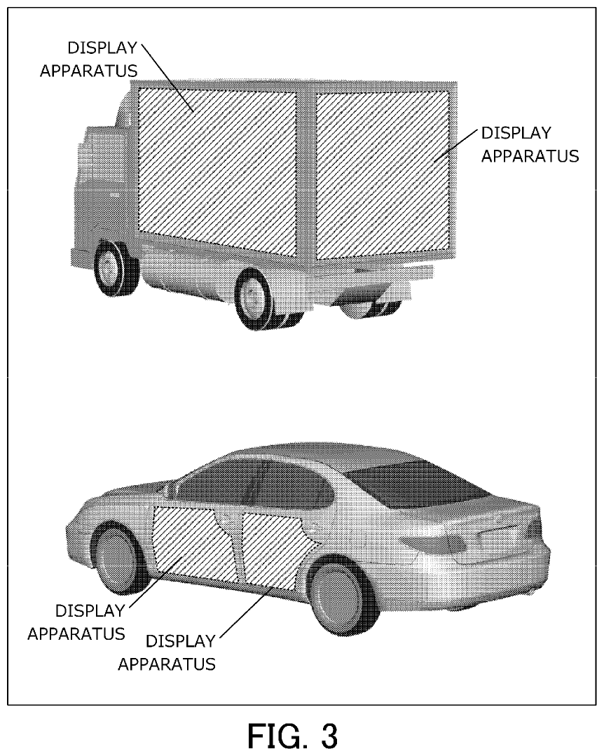

The display apparatus 101 includes a plurality of display apparatuses provided on the outside of the vehicle 10. As illustrated in FIG. 3, the vehicle 10 in the system according to the embodiment has a plurality of display apparatuses 101A, 101B, . . . , 101n that face outward. The display apparatuses will be collectively designated as the display apparatus 101, where identification of individual display apparatuses is not necessary.

The display apparatus 101 may be a liquid crystal display, an organic electroluminescence display, an LED matrix, or a projector.

The number of display apparatuses provided on one vehicle 10 varies depending on the type or model of the vehicle 10. Display apparatuses may be provided on different portions of the vehicle 10, for example, on the right and left sides, the rear, and the top of the vehicle. For example, a truck may have three display apparatuses provided on the right side, the left side, and the rear of the vehicle. A sedan may have four display apparatuses provided on the front door on the left side, the rear door on the left side, the front door on the right side, and the rear door on the right side.

Display apparatuses 101 may be provided at positions other than those described above. For example, if it is possible to project images on a sheet of glass, display apparatuses may be provided on windows (e.g. side and rear windows).

The control unit 102 is a computing device that controls the function of outputting advertisements among the functions of the vehicle 10. The control unit 102 may be implemented by a computational processing unit, such as a CPU (Central Processing Unit).

The control unit 102 includes three functional modules, which include an advertisement obtaining part 1021, an advertisement outputting part 1022, and an informing part 1023. These functional modules may be implemented by executing programs stored in the storage unit 103 (described later) by a CPU.

The advertisement obtaining part 1021 obtains data (advertisement data) relating to an advertisement to be output on the display apparatus 101 from the server apparatus 20. It is preferred that the advertisement data be obtained just before the vehicle 10 starts to travel or while the vehicle 10 is travelling, though the timing of obtaining the advertisement data is not limited to these. The advertisement data may be obtained at the time when the ignition is turned on, when a destination is set, or when the vehicle 10 starts to travel. The advertisement data obtained by the advertisement obtaining part 1021 is stored in the storage unit 103, which will be described later.

The advertisement outputting part 1022 outputs an advertisement contained in the advertisement data to the display apparatus 101. A condition for outputting the advertisement may be specified in the advertisement data, and the advertisement may be output only when the condition is met. The advertisement data may designate the position and the size of the display apparatus, and the advertisement outputting part 1022 may output the advertisement according to the designations.

The informing part 1023 sends information about display of an advertisement to the server apparatus 20. Specifically, the informing part 1023 collects information about the present location of the vehicle, identification data of the advertisement presently displayed, and other information relating to the advertisement and sends them to the server apparatus 20.

Details of processing executed by each module will be described later.

The storage unit 103 includes a main storage device and an auxiliary storage device. The main storage device is a memory into which programs executed by the control unit 102 and data used by such control programs are loaded. The auxiliary storage device is a device in which the programs executed by the control unit 102 and the data used by the control programs are stored. An operating system for executing the programs may also be stored in the auxiliary storage device. Programs stored in the auxiliary storage device are loaded into the main storage device and executed by the control unit 102 to implement the aforementioned functions.

The communication unit 104 is a wireless communication interface that connects the vehicle 10 to the network. The communication unit 104 provides access to the network via, for example, a wireless LAN or a mobile communication service based on 3G or LTE.

The location information acquisition unit 105 is a unit configured to acquire location information of the vehicle 10. The location information acquisition unit 105 includes, for example, a GPS module and acquires location information (e.g. latitude and longitude) of the vehicle 10.

FIG. 2 is given only to illustrate an exemplary configuration, and all or some of the functions shown in FIG. 2 may be implemented by circuits dedicated to the functions. Main and auxiliary storage devices other than those illustrated may be employed in combination to store and/or execute programs.

Next, the configuration of the server apparatus 20 will be described.

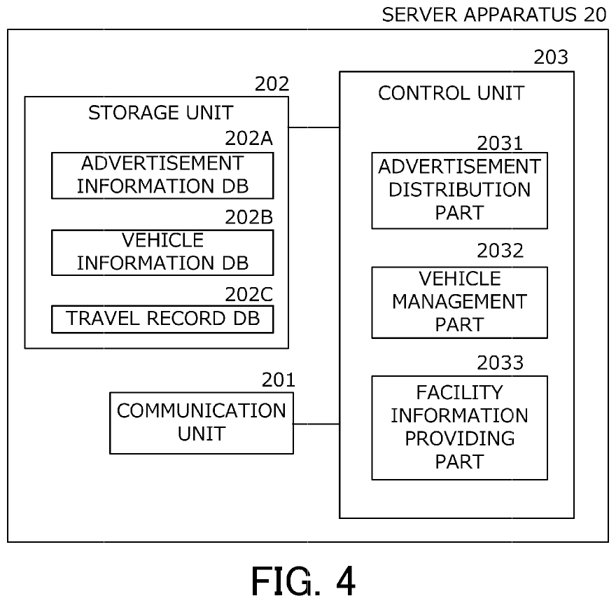

FIG. 4 is a diagram illustrating the system configuration of the server apparatus 20. The server apparatus 20 includes a communication unit 201, a storage unit 202, and a control unit 203.

The server apparatus 20 is constituted by an ordinary computer. Specifically, the server apparatus 20 is a computer including a processor(s), such as a CPU and/or a GPU, a main storage device(s), such as a RAM and/or a ROM, and an auxiliary storage device(s), such as an EPROM, a hard disk drive and/or a removable medium. Examples of the removable medium include a USB memory and a recording disc medium, such as a CD or DVD. What is stored in the auxiliary storage device includes an operating system (OS), various programs, and various tables. The programs stored in the auxiliary storage device are loaded into a workspace of the main storage device and executed to control various components, thereby providing appropriate functions for achieving desired purposes, which will be described later. All or some of the functions may be implemented by a hardware circuit, such as an ASIC or an FPGA. The server apparatus 20 may be constituted by a single computer or a plurality of computers that work in cooperation with each other.

The communication unit 201 is a communication interface that connects the server apparatus 20 to the network. The communication unit 201 includes, for example, a network interface board and a wireless communication circuit for providing wireless communication.

The storage unit 202 includes a main storage device and an auxiliary storage device. The main storage device is a memory into which programs executed by the control unit 203 and data used by such control programs are loaded. The auxiliary storage device is a device in which the programs executed by the control unit 203 and the data used by the control programs are stored. The main storage device and the auxiliary storage device are similar to those in the storage unit 103 and will not be described in further detail.

What is stored in the storage unit 202 also includes an advertisement information database 202A, a vehicle information database 202B, and a travel record data base 202C.

The advertisement information database 202A is a database in which data relating to advertisements to be distributed to the vehicles 10 is stored. Such data is created by an advertiser(s).

The vehicle information data base 202B is a database in which information about properties and characteristics of the vehicles 10 are stored. Such data is created when the vehicles 10 are registered in the system.

The travel record database 202C is a database in which records of travel of the vehicles 10 are stored. The record of travel includes, for example, a route or locations that the vehicle 10 has travelled, the status of display of an advertisement, and identification data of the displayed advertisement. The stored data is updated on the basis of information collected from the vehicles 10.

These databases are created by managing data stored in the storage device by a database management system program (DBMS program) executed by the processor. The databases used in the system according to the embodiment are, for example, relational databases.

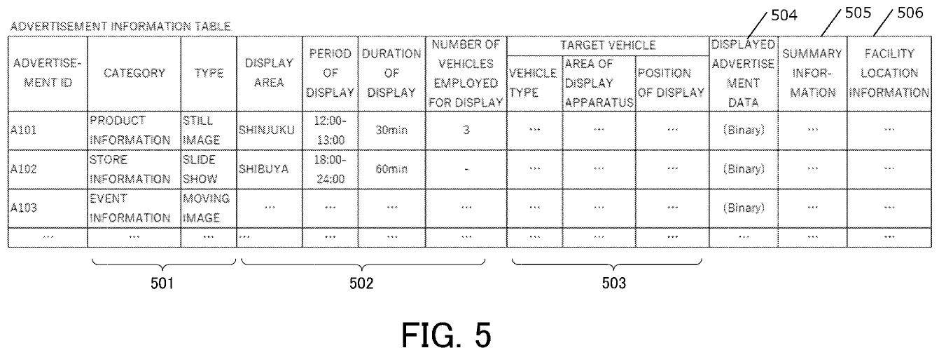

Data stored in the advertisement information database 202A will now be described with reference to FIG. 5. FIG. 5 illustrates an example of the content of an advertisement information table stored in the advertisement information database 202A. As illustrated, the information stored in the advertisement information table includes identification data of the advertisement (advertisement ID), information relating to properties of the advertisement (501), information relating to conditions for display of the advertisement (502), information designating a vehicle to be employed to display the advertisement (503), data to be output to the display apparatus 101 of the vehicle (displayed advertisement data 504), summary information that summarizes the advertisement (505), and information specifying the location of a store or facility related to the advertisement (506).

The displayed advertisement data may be, for example, still image data or moving image data.

The displayed advertisement data used in the system according to this embodiment is accompanied by optically-readable information that uniquely identifies the advertisement. This information will be hereinafter referred to as “accompanying information”. The accompanying information used in the system according to this embodiment is a two-dimensional code, a mechanically-readable character string or pattern, or the like that represents the advertisement ID. This information is displayed together with the advertisement.

The summary information may be a document written in a plain text or a markup language.

Further, the facility location information may be data specifying the latitude and longitude.

Each data stored in the advertisement information database 202A will be referred to as “advertisement data”.

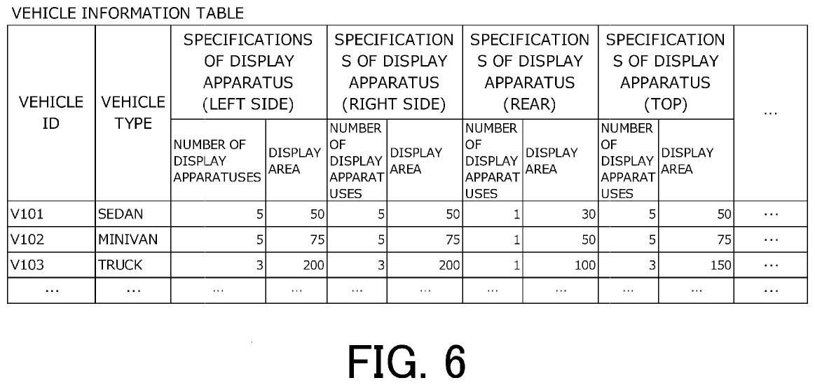

Next, data stored in the vehicle information database 202B will be described with reference to FIG. 6. FIG. 6 illustrates an example of the content of a vehicle information table stored in the vehicle information database 202B. The information stored in the vehicle information table includes information about the type of the vehicle and information about the display apparatus. Examples of the information about the display apparatus include, but are not limited to, the positions at which the display apparatuses are provided, the number of panels in each position, and the area of each display.

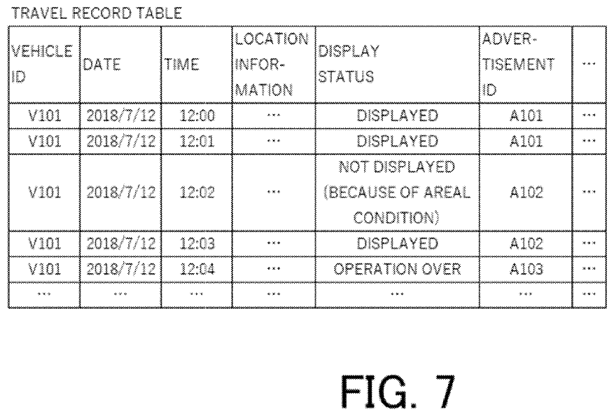

Data stored in the travel record database 202C will be described with reference to FIG. 7. FIG. 7 illustrates an example of the content of a travel record table stored in the travel record database 202C. Information stored in the travel record table includes identification data of the vehicle (VEHICLE ID), date and time, location information (e.g. latitude and longitude) of the vehicle 10, the status of display of advertisement, identification data of the advertisement displayed at the time (ADVERTISEMENT ID).

The display status is information indicating the status of display of advertisement, examples of which include “DISPLAYED”, “NOT DISPLAYED”, “PARKED”, and “OPERATION OVER” (indicating that the operation has ended). When display of advertisement is not performed for some reason, such as that the vehicle 10 is travelling outside the area designated by the advertiser or the time of travel does not fall in the designated time period, the display status may include the reason.

How the data stored in the databases is used will be described later.

The control unit 203 is a computing unit that executes control performed by the server apparatus 20. The control unit 203 may be implemented by a computational processing unit, such as a CPU.

The control unit 203 includes as functional modules an advertisement distribution part 2031, a vehicle management part 2032, and a facility information providing part 2033. These three functional modules may be implemented by executing programs stored in auxiliary storage device by the CPU.

The advertisement distribution part 2031 determines an advertisement to be displayed by a designated vehicle 10 and sends corresponding advertisement data to the vehicle 10.

The vehicle management part 2032 periodically communicates with the vehicles 10 to collect location information of the vehicles 10 and identification data of the advertisements displayed by the vehicles 10 and updates the travel record database 202C.

In response to a request from an on-vehicle terminal 30, the facility information providing part 2033 identifies the advertisement that is supposed to have seen by the user on the basis of the information sent from the on-vehicle terminal 30, retrieves location information of a facility related to the advertisement (facility location information), and sends it to the on-vehicle terminal 30. This process will be specifically described later.

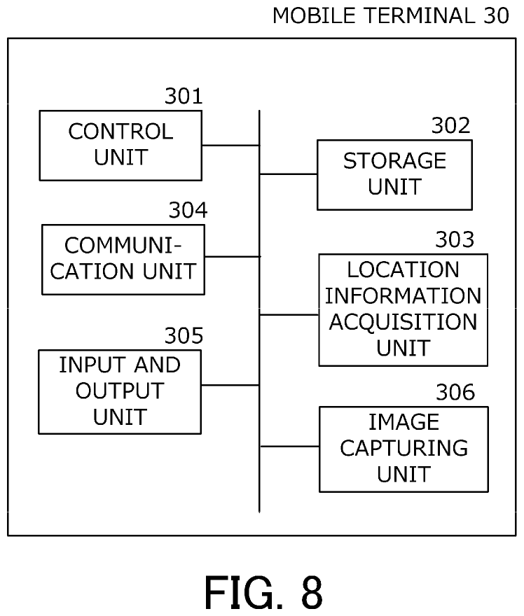

Next, the configuration of the on-vehicle terminal 30 will be described. FIG. 8 is a diagram illustrating the system configuration of the on-vehicle terminal 30.

The on-vehicle terminal is an apparatus provided in a vehicle on which a user who see advertisements is aboard. Such a vehicle will be hereinafter referred to as a “user vehicle”. The on-vehicle terminal 30 may be either a terminal fixed on a user vehicle or a portable computer, such as a smartphone, a cellular phone, a tablet computer, a personal information terminal, a laptop personal computer, or a wearable computer (e.g. smartwatch).

The on-vehicle terminal 30 includes a control unit 301, a storage unit 302, a location information acquisition unit 303, a communication unit 304, an input and output unit 305, and an image acquiring unit 306.

The control unit 301 is a computing unit that executes control performed by the on-vehicle terminal 30. The control unit 301 may be implemented by a computational processing unit, such as a CPU (Central Processing Unit).

The control unit 301 executes the function of sending an inquiry to the server apparatus to request information about the location of a facility related to an advertisement displayed by a vehicle 10. Moreover, the control unit 301 executes the function of obtaining a route to the facility using information about its location it has received to guide the user.

Details of its processing will be described later.

The storage unit 302 includes a main storage device and an auxiliary storage device. The main storage device is a memory into which programs executed by the control unit 301 and data used by such control programs are loaded. The auxiliary storage device is a device in which the programs executed by the control unit 301 and the data used by the control programs are stored. A package of application programs executed by the control unit 301 may be stored in the auxiliary storage device. An operating system for executing the application programs may also be stored in the auxiliary storage device. Programs stored in the auxiliary storage device are loaded into the main storage device and executed by the control unit 301 to execute processing described in the following.

The main storage device may include a RAM (Random Access Memory) and/or a ROM (Read Only Memory). The auxiliary storage device may include an EPROM (Erasable Programmable ROM) and/or a hard disk drive (HDD). The auxiliary storage device may also include a removable medium, namely portable recording medium. Examples of the removable medium include a USB memory (Universal Serial Bus memory) and a recording disc medium, such as a CD (Compact Disc) or a DVD (Digital Versatile Disc).

The location information acquisition unit 303 is a unit configured to acquire location information of the on-vehicle terminal 30. The location information acquisition unit 303 includes, for example, a GPS module and acquires location information (e.g. latitude and longitude) of the on-vehicle terminal 30.

The communication unit 304 is a wireless communication interface that connects the on-vehicle terminal 30 to the network. The communication unit 304 provides access to the network via, for example, a wireless LAN or a mobile communication service based on 3G or LTE.

The input and output unit 305 is a unit configured to receive input operations by a user and providing information to the user. The input and output unit 305 of the on-vehicle terminal 30 according to the embodiment is constituted by a single touch-panel display, which includes a liquid crystal display, its control unit, a touch panel, and its control unit.

The image acquiring unit 306 is a unit configured to acquire images from a camera (on-vehicle camera) that can capture images of the surroundings of the user vehicle. The on-vehicle camera may be provided at any position on the user vehicle from which it can capture images of advertisements displayed by vehicles 10.

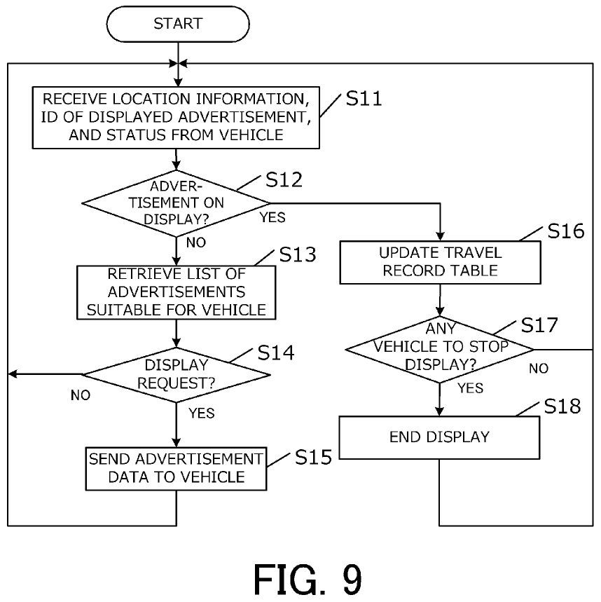

Next, we will describe how the advertisement distribution system according to the embodiment distributes advertisements to the vehicles 10 to cause them to display the advertisements. FIG. 9 is a flow chart of a process executed by the server apparatus 20. The management server 20 executes the process illustrated in FIG. 9 periodically for each of the vehicles 10 under its management.

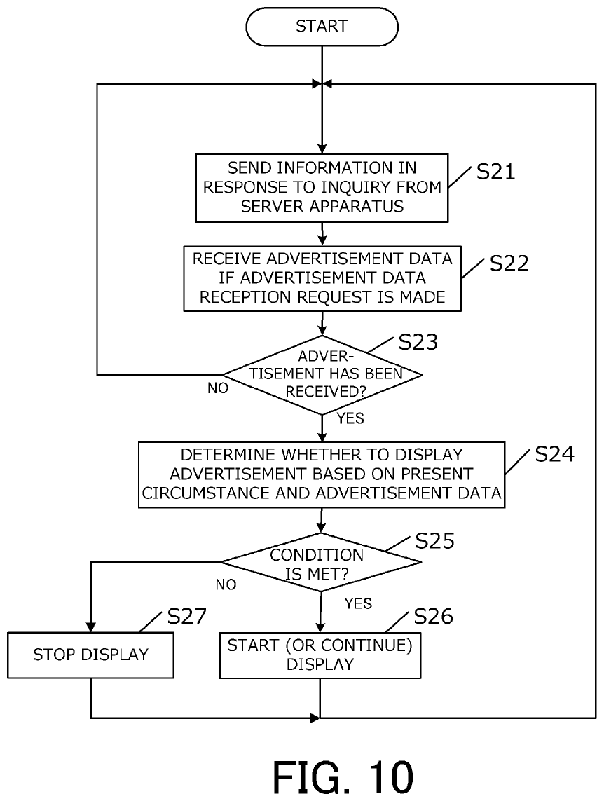

Firstly in step S11, the server apparatus 20 collects from the vehicles 10 under its management location information, the identification data of the presently displayed advertisement, and the status of display of advertisement. Specifically, the vehicle management part 2032 sends an inquiry to each of the vehicles 10 (specifically, the informing part 1024 thereof), and the informing part 1024 of each vehicle 10 sends location information acquired by the location information acquisition unit 105 in response to the inquiry. The informing part 1024 also sends information about whether or not there is an advertisement presently on display (with the ID of the advertisement, if affirmative) and the status of display of advertisement. Details of the processing performed by the vehicle 10 will be described later with reference to FIG. 10.

While in the system according to the embodiment the server apparatus 20 periodically sends an inquiry to the vehicle 10, the vehicle 10 may periodically send the aforementioned information to the server apparatus 20 by push communication alternatively. In this alternative case, the processing of step S11 may be executed at a point in the process different from that in FIG. 9.

Then, in step S12, the advertisement distribution part 2031 determines whether or not the subject vehicle 10 (namely, the vehicle for which this process is being performed) is presently displaying an advertisement. If a negative determination is made, the process proceeds to step S13, where the advertisement distribution part 2031 retrieves one or more advertisements that the subject vehicle 10 can display.

Whether or not there are advertisements that a certain vehicle 10 can display can be determined by whether or not the properties of the vehicle 10 meet the condition set for each advertisement. For example, in the case where a condition relating to the type of the vehicle and its display apparatus is set for an advertisement as shown in columns 503 in the table in FIG. 5, whether or not the advertisement can be displayed is determined by whether or not the properties of the vehicle 10 meet the condition.

Whether or not there are advertisements that a certain vehicle 10 can display may be determined by consulting information related to the vehicle 10. For example, information about the taste of the owner of the vehicle 10 may be stored in the vehicle information table, and advertisements to be distributed to the vehicle 10 may be determined using this information.

If there is an advertisement(s) for which the subject vehicle 10 meets the condition, information relating to the advertisement(s) is extracted and stored temporarily.

A determination as to whether or not conditions relating to the area and time among the conditions set for an advertisement are met is not made in this step. This is because whether such conditions are met or not changes depending on the state of travel of the vehicle 10. This determination is made by the vehicle 10 to which the advertisement has been distributed, and whether or not the advertisement can be displayed is determined by the vehicle 10. If it is apparent that a condition set for an advertisement will not be met, that advertisement may be excluded in this step.

Then, in step S14, it is determined whether or not a request for display of the advertisement(s) is to be made to the subject vehicle 10. For example, if one or more advertisements were extracted in step S13, an affirmative determination is made in this step. Then, in step S15, advertisement data associated with the extracted advertisement(s) is sent to the subject vehicle 10.

If an affirmative determination is made in step S12, it means that the subject vehicle 10 has already been travelling while displaying a certain advertisement. Then, in step S16, the travel record table is updated using the location information and the advertisement ID received from the vehicle 10. Specifically, the vehicle management part 2032 adds a record containing the vehicle ID, the date and time, the location information, the status, the ID of the displayed advertisement, information about the number of mobile terminals, and mobile terminal information the travel record table stored in the travel record database 202C.

Then, in step S17 it is determined whether or not there is a vehicle(s) that is to stop displaying the advertisement. In this step, it is determined whether or not there is an advertisement(s) for which the condition for ending the display is met on the basis of information received from the vehicles 10. For example, in the case where a total display time is designated for a certain advertisement, if the total display time of this advertisement has elapsed, it is determined that display of this advertisement is to be ended. Furthermore, if the operation (or travel) of a vehicle 10 that displays a certain advertisement ends (e.g. if the ignition is turned off), it is determined that display of this advertisement is to be ended.

If an affirmative determination is made in step S17, the process proceeds to step S18, where display of advertisement by the pertinent vehicle(s) is ended. Specifically, the advertisement distribution part 2031 sends a command to end the display of advertisement to the pertinent vehicle(s) 10.

The above-described process is executed repeatedly for every vehicle 10 under the management of the server apparatus 20.

Next, a process executed by each vehicle 10 will be described.

FIG. 10 is a flow chart of a process executed by the vehicle 10. The process illustrated in FIG. 10 is executed by the vehicle 10 at the time when the inquiry from the server apparatus 20 is received.

Firstly, in step S21, the informing part 1024 sends the following information to the server apparatus 20:

(1) location information acquired by the location information acquisition unit 105

(2) the presence/absence of displayed advertisement (with its ID, if present)

(3) the status of display of advertisement

While in the system according to this embodiment the vehicle 10 sends information in response to the inquiry sent from the server apparatus 20, the vehicles 10 may send the aforementioned information to the server apparatus 20 at predetermined intervals by push communication alternatively. In this alternative case, the processing of step S21 may be executed at a point in the process different from that in FIG. 10.

Then, in step S22, it is determined whether or not reception of advertisement data is requested by the server apparatus 20, and if it is requested, the vehicle 10 receives the advertisement data.

Then, in step S23, it is determined whether or not the advertisement outputting part 1022 has already received the advertisement data from the server apparatus 20. If a negative determination is made in step S23, the process returns to step S21. If an affirmative determination is made in step S23, the process proceeds to step S24, where it is determined whether or not the advertisement is to be displayed on the basis of comparison between the present circumstance and the condition set in the advertisement data.

For example, if it is designated in the advertisement data that the advertisement should be displayed only in a designated area, whether the advertisement is to be displayed or not is determined on the basis of the result of comparison of the condition relating to the area and the location information acquired by the location information acquisition unit 105. If it is designated in the advertisement data that the advertisement should be displayed only in a designated time period, whether the advertisement is to be displayed or not is determined on the basis of the result of comparison of the condition relating to the time period and the present date and time.

While area and time period are given as examples of conditions for determining whether the advertisement is to be displayed or not, other conditions based on which the vehicle 10 can make the determination may be set.

If the result of determination in step S24 indicates that the condition is met (Yes in step S25), the process proceeds to step S26, where display of the advertisement is started (or continued, if the advertisement has already been displayed). If the condition is not met (No in Step S25), the process proceeds to step S27, where display of the advertisement is ended.

The vehicle 10 displays the advertisement by the above process.

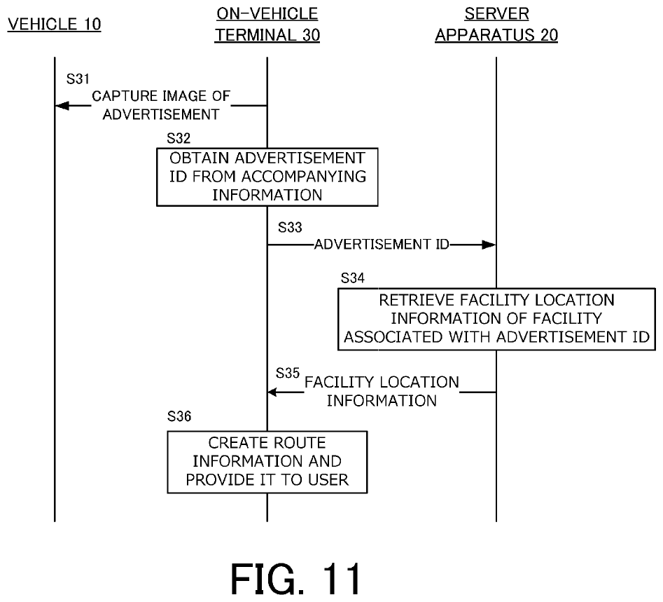

Next, we will described the process of guiding a user who has seen an advertisement displayed by a vehicle to a location related to the advertisement with reference to FIG. 11.

If a user who has seen an advertisement performs a certain operation on the on-vehicle terminal 30 (through the input and output unit 305) provided in the user vehicle, the image acquiring unit 306 acquires an image through the on-vehicle camera (step S31). The image acquired here is an image containing an image of the advertisement seen by the user.

Then, the on-vehicle terminal 30 (specifically, the control unit 301 thereof) obtains an advertisement ID that uniquely identifies the advertisement from accompanying information contained in the image acquired by the image acquiring unit 306 (step S32). For example, if the accompanying information is a two-dimensional code, the control unit 301 decodes the two-dimensional code to obtain the advertisement ID.

The advertisement ID thus obtained is sent to the server apparatus 20 (step S33). Then, the server apparatus 20 (specifically, the facility information providing part 2033) consults the advertisement information database 202A to extract the record associated with the advertisement ID it has received and retrieve the facility location information associated with it (step S34).

The facility location information retrieved as above is sent to the on-vehicle terminal 30 (step S35). After receiving the facility location information, the on-vehicle terminal 30 creates information about a route (route information) from its present location to the facility (step S36). The on-vehicle terminal 30 may create the route information using map information stored in it or retrieve the route information using an external service.

The on-vehicle terminal 30 provides the route information thus created to the user in response to a user's request. For example, the on-vehicle terminal 30 may ask the user whether he/she wants it to start a route guidance or not by the input and output unit 305, and if the user answers in the affirmative, it may start the route guidance.

As above, in the system according to the first embodiment, the on-vehicle terminal 30 identifies an advertisement using an image captured by the on-vehicle camera and then sends an inquiry to the server apparatus 20, which manages distribution of the advertisement, to obtain facility location information related to the advertisement. Thus, the on-vehicle terminal 30 can guide the user who has seen the advertisement to a location related to the advertisement.

While in the above-described system according to the first embodiment the process illustrated in FIG. 11 is started in response to a user's request, the on-vehicle terminal 30 may start the process automatically upon automatically recognizing an advertisement based on an image acquired by the on-vehicle camera alternatively. In this alternative case, the on-vehicle terminal 30 automatically collects information about a location related to the advertisement. The on-vehicle terminal 30 may be configured to ask the user whether he/she wishes it to create route information based on the collected facility location information.

### Modification of First Embodiment

While in the system according to the first embodiment the advertisement ID is obtained based on an image captured by the on-vehicle camera, the advertisement ID may be sent by inter-vehicle communication between the user vehicle and a vehicle 10. For example, in response to an operation performed by the user, the on-vehicle terminal 30 may request a vehicle 10 located near the user vehicle to send the advertisement ID. Then, the vehicle 10 may send the advertisement ID in response to the request. This eliminates the need for accompanying information.

When there are a plurality of vehicles 10 located near the user vehicle, the on-vehicle terminal 30 may obtain facility location information of a plurality of facilities to allow the user to select one or some of them afterward, or let the user to designate one of the vehicles 10 to communicate with.

### Second Embodiment

In the above-described system according to the first embodiment, advertisement ID is used as information for identifying an advertisement displayed by a vehicle 10. In the second embodiment, information about the license plate of the vehicle 10 is used to identify the advertisement.

In the system according to the second embodiment, the vehicle information table stored in the vehicle information database 202B includes license plate information associated with each vehicle 10.

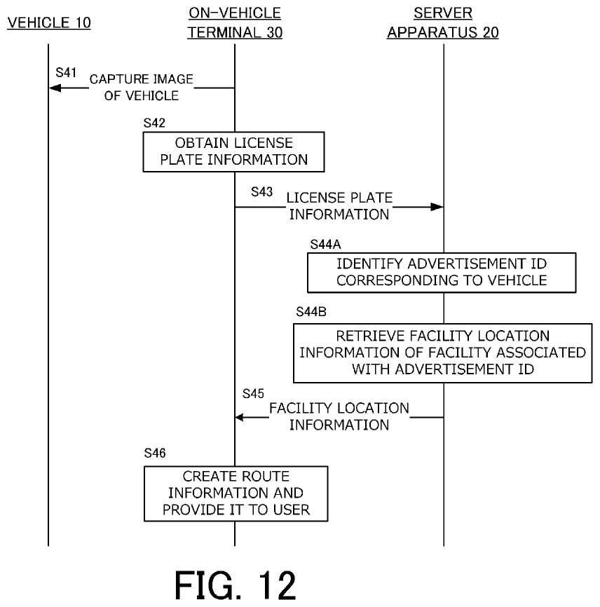

In the following, we will describe how the system according to the second embodiment guides a user who has seen an advertisement displayed by a vehicle 10 to a location related to the advertisement with reference to FIG. 12.

When the user who has seen an advertisement performs a certain operation on the on-vehicle terminal 30 (through the input and output unit 35) provided in the user vehicle, the image acquiring unit 306 acquires an image through the on-vehicle camera (step S41). The processing in this step S41 differs from the processing of step S31 according to the first embodiment in that the acquired image contains an image of the license plate of the vehicle 10.

Then in step S42, the on-vehicle terminal 30 obtains license plate information from the acquired image. While in this embodiment the license plate information is used to uniquely identify the vehicle, other information may be used, if the vehicle ID can be uniquely determined by later processing.

The license plate information thus obtained is sent to the server apparatus 20 (step S43). Then, the server apparatus 20 (specifically, the facility information providing part 2033) consults the vehicle information database 202B to extract the record associated with the license plate information it has received and retrieve the corresponding vehicle ID. Moreover, the server apparatus 20 consults the travel record database 203C to identify the advertisement ID of the advertisement displayed by the corresponding vehicle (step S44A). Then, the server apparatus 20 consults the advertisement information database 202A to extract the record corresponding to the advertisement ID and retrieve the facility location information associated with it (step S44B).

The processing of steps S45 and S46 is the same as the processing of steps S35 and S36 in the process according to the first embodiment and will not be described further.

### Modification of Second Embodiment

While in the system according to the second embodiment, the license plate information is obtained based on an image captured by the on-vehicle camera, the license plate information may be sent by inter-vehicle communication between the user vehicle and a vehicle 10. For example, in response to an operation performed by the user, the on-vehicle terminal 30 may request a vehicle 10 located near the user vehicle to send the license plate information. Then, the vehicle 10 may send the license plate information in response to the request.

When there are a plurality of vehicles 10 located near the user vehicle, the on-vehicle terminal 30 may obtain facility location information of a plurality of facilities to allow the user to select one or some of them afterward, or let the user to designate one of the vehicles 10 to communicate with. Alternatively, the vehicle ID may be sent by inter-vehicle communication instead of the license plate information.

### Third Embodiment

In a system according to the third embodiment, advertisements are identified only on the basis of location information and date and time information without using an on-vehicle camera.

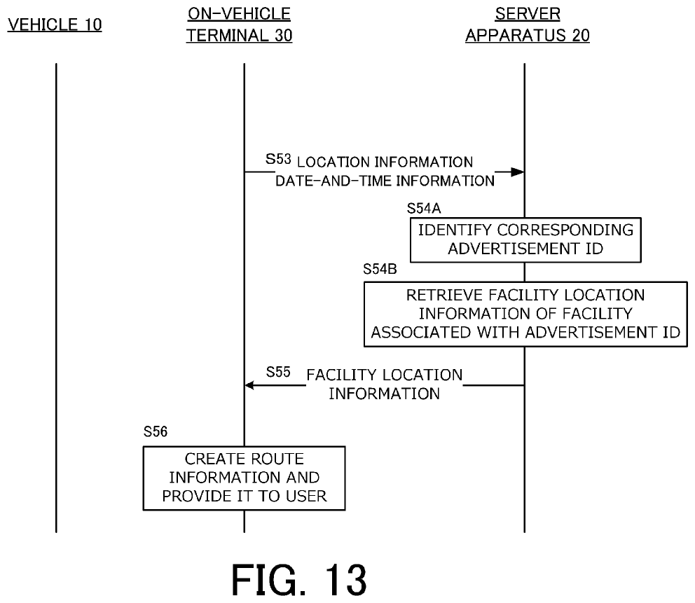

In the following, we will describe how the system according to the third embodiment guides a user who has seen an advertisement displayed by a vehicle 10 to a location related to the advertisement with reference to FIG. 13.

When the user who has seen an advertisement performs a certain operation on the on-vehicle terminal 30 (through the input and output unit 305) provided in the user vehicle, the on-vehicle terminal 30 sends location information acquired by the location information acquisition unit 303 and data-and-time information acquired by the control unit 301 to the server apparatus 20 (step S53).

Then, the server apparatus 20 searches the travel record database 203C using the location information and the date-and-time information it has received as keys to identify the vehicle (vehicle ID) and the advertisement (advertisement ID) displayed by the vehicle (step S54A). In the process of identifying the vehicle, it is preferred that a certain margin be added to the location information and the date-and-time information.

Then, the server apparatus 20 consults the advertisement information database 202A to extract the record corresponding to the advertisement ID and retrieve the facility location information associated with it (step S54B).

The processing of steps S55 and S56 is the same as the processing of steps S35 and S36 in the process according to the first embodiment and will not be described further.

In the system according to the third embodiment, there is no interaction between the on-vehicle terminal 30 and the vehicle 10. Therefore, advantageous effects the same as those in the system according to the first or second embodiment can be enjoyed by a simple configuration.

When there are a plurality of vehicles 10 located near the user vehicle, the server apparatus 20 may obtain facility location information of a plurality of facilities to allow the user to select one or some of them afterward.

### Fourth Embodiment

In the system according to the fourth embodiment, the facility location information is transmitted directly by inter-vehicle communication between the on-vehicle terminal and the vehicle 10 without the intervention of the server apparatus 20.

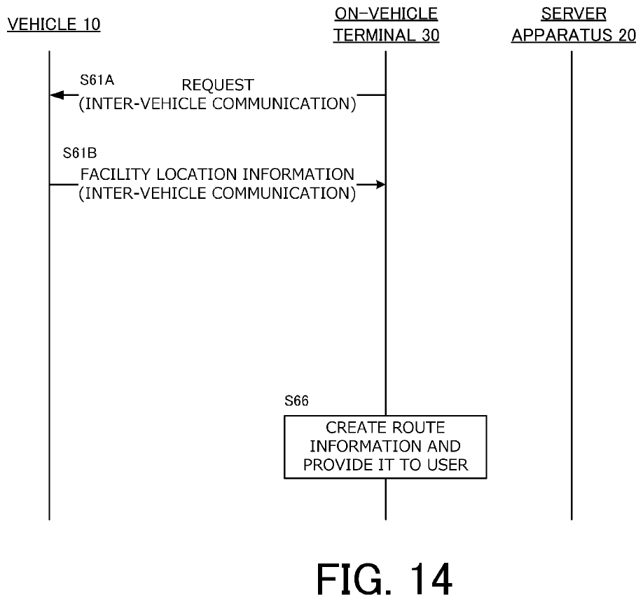

In the following, we will describe how the system according to the fourth embodiment guides a user who has seen an advertisement displayed by a vehicle 10 to a location related to the advertisement with reference to FIG. 14.

When the user who has seen an advertisement performs a certain operation on the on-vehicle terminal 30 (through the input and output unit 305) provided in the user vehicle, the control unit 301 of the on-vehicle terminal 30 requests a vehicle(s) 10 located near the user vehicle to send facility location information by inter-vehicle communication (step S61A).

When receiving the request, the vehicle 10 retrieves facility location information related to the advertisement that the vehicle 10 is presently displaying from the advertisement data stored in it and sends the facility location information to the on-vehicle terminal 30 (step S61B).

The processing of step S66 is the same as the processing of steps S36 in the process according to the first embodiment and will not be described further.

When there are a plurality of vehicles 10 located near the user vehicle, the on-vehicle terminal 30 may obtain facility location information of a plurality of facilities to allow the user to select one or some of them afterward, or let the user to designate one of the vehicles 10 to communicate with.

### Modifications

The above embodiments are only for the illustrative purpose. Appropriate modifications can be made thereto without departing from the essence of the present disclosure.

For example, while in the systems according to embodiments the route information is obtained by the on-vehicle terminal 30, the route information may be obtained by the server apparatus 20 or other apparatus that provides a route search service.

In cases where there are a plurality of locations related to an advertisement or where the user cannot pick up an advertisement he/she has seen from a plurality of advertisements, facility location information for a plurality of facilities and route information for a plurality of facilities may be provided to allow the user to make a choice. In such cases, the facilities may be prioritized by a certain measure and filtered according to the priority. Moreover, the order of providing the information may be arranged according to the priority. The measure of the priority may be, for example, the taste of the user or the distance between the vehicles.

While in the description of the embodiments the latitude and longitude is mentioned as an example of the facility location information, the facility location information may be any information relating to a specific location related to the advertisement, which is not necessarily information directly indicating a geographical location. For example, identification data that uniquely identifies a facility or store may be used instead.

The processing and units that have been described in the foregoing may be employed in any combinations so long as it is technically feasible to do so.

A process described to be performed by one apparatus may be performed by a plurality of apparatuses in a distributed manner. A process described to be performed by different apparatuses may be performed by a single apparatus. The hardware configuration (or server configuration) employed to implement the functions of a computer system may be modified flexibly.

The present disclosure can be carried out by supplying a computer program(s) that implements the functions described in the above description of the embodiments to a computer to let one or more processors of the computer read and execute the program(s). Such a computer program(s) may be supplied to the computer by a computer-readable, non-transitory storage medium that can be connected to a system bus of the computer, or through a network. Examples of the computer-readable, non-transitory storage medium include any type of disc medium including, a magnetic disc, such as a floppy (registered trademark) disc and a hard disk drive (HDD), and an optical disc, such as a CD-ROM, a DVD disc and a Blu-ray disc, a read-only memory (ROM), a random access memory (RAM), an EPROM, an EEPROM, a magnetic card, a flash memory, an optical card, and any type of medium suitable for storage of electronic commands.

What is claimed is:

1. An information processing apparatus comprising a control unit configured to execute the processing of:
obtaining first information, which relates to a specific location related to an advertisement displayed by a display apparatus provided on a first vehicle;
obtaining route information, which is information about a route to the specific location, on the basis of the first information; and
providing the obtained route information to a user.

2. An information processing apparatus according to claim 1, wherein
the control unit obtains the first information by performing an inter-vehicle communication with the first vehicle.

3. An information processing apparatus according to claim 1, wherein
the control unit obtains the first information from a server apparatus that manages distribution of the advertisement to the first vehicle.

4. An information processing apparatus according to claim 3, wherein
the control unit sends second information to the server apparatus, the second information being information used to identify the advertisement displayed by the first vehicle.

5. An information processing apparatus according to claim 4, wherein
the control unit creates the second information on the basis of an image of the first vehicle captured by a camera provided on a second vehicle on which the user is aboard.

6. An information processing apparatus according to claim 4, wherein
the control unit obtains the second information by performing an inter-vehicle communication with the first vehicle.

7. An information processing apparatus according to claim 1, wherein
when the control unit obtains a plurality of pieces of the first information, the control unit obtains a plurality of pieces of the route information corresponding respectively to them and provide the plurality of pieces of route information to the user with prioritization.

8. An information processing method comprising the following steps executed by an information processing apparatus:
obtaining first information, which relates to a specific location related to an advertisement displayed by a display apparatus provided on a first vehicle;
obtaining route information, which is information about a route to the specific location on the basis of the first information; and
providing the obtained route information to a user.

9. A non-transitory computer readable storing medium recording a computer program for causing a computer to perform an information processing method comprising: the steps of:
obtaining first information, which relates to a specific location related to an advertisement displayed by a display apparatus provided on a first vehicle;
obtaining route information, which is information about a route to the specific location, on the basis of the first information; and
providing the obtained route information to a user.
